(19) United States
(12) Patent Application Publication
(10) Pub. No.: US 2020/0071095 A1
(43) Pub. Date: Mar. 5, 2020

(54) Convenient container for unloading

(71) Applicant: Xianrong Wang, Shanghai City (CN)

(72) Inventor: Xianrong Wang, Shanghai City (CN)

(21) Appl. No.: 16/675,204

(22) Filed: Nov. 5, 2019

(30) Foreign Application Priority Data
May 6, 2019 (CN) 2019103717767

(51) Int. Cl. B65G 65/40; B65D 83/00; B65D 25/38; B65G 13/071; B65G 39/12; B65G 41/00

(52) U.S. Cl. CPC B65G 65/40; B65D 83/00; B65G 41/006; B65G 13/071; B65G 39/12; B65D 25/38

(57) ABSTRACT

This invention discloses a convenient container for unloading, including a box body (11), and a cargo chamber (13) used for storing cargoes is arranged in the box body (11), and an arc-shaped cavity (49) communicated with the cargo cavity (13) is formed in the right end of the cargo cavity (13), and a rotatable upper door (14) is arranged in the arc-shaped cavity (49), the arc-shaped cavity (49) is provided with a rotatable lower door (15). The invention is simple in structure, convenient to operate and convenient to maintain; the device can automatically convey the cargoes to the right end of the container, so that manual carrying of workers is not needed, the labor intensity is reduced, and the unloading efficiency of cargoes is improved.

### TECHNICAL FIELD

The present invention relates to a convenient container for unloading.

### BACKGROUND OF THE INVENTION

Container is the main carrier of goods transportation because it can load a large number of goods and is convenient for mechanical equipment loading and unloading. However, when unloading goods, many users carry the goods to the end of the container, and because the container structure is large in depth, large in volume or high in weight is not easy to handle, which seriously affects the unloading efficiency, the invention aims to design a container that improves the efficiency of loading and unloading goods.

### BRIEF SUMMARY OF THE INVENTION

The purpose of the invention is to provide a convenient container for unloading to overcome the problems existing in the prior art.

A convenient container for unloading comprises a box body, wherein a goods cavity used for storing cargoes is arranged in the box body, and an arc-shaped cavity communicated with the goods cavity is formed in the right end of the goods cavity, and a rotatable upper door is arranged in the arc-shaped cavity, the arc-shaped cavity is provided with a rotatable lower door, wherein, and the lower door is used for transmitting power with the upper door through a belt, the lower door can be in contact fit with the upper door to seal the cargo cavity, wherein, and an action cavity is formed in the bottom wall of the cargo cavity, one hundred groups of rolling shafts which are convenient for goods to slide in the goods cavity are arranged in the action cavity, and the rear end of the roller shaft is provided with a cargo roller positioned in the cargo cavity, wherein a rolling shaft is arranged at the front end of the rolling shaft; a rotating shaft is arranged at the front end of the rolling shaft, and a transmission device for transmitting power to the slave gear is arranged in the action cavity, and then the roller can be driven by the gear to rotate through the roller shaft, and the goods are conveyed to the rightmost side of the goods cavity, and a power cavity is formed in the right wall of the action cavity, and a reciprocating cavity is arranged in the right wall of the power cavity, an oil cylinder is arranged in the right wall of the hydraulic cavity, a door opening device used for rotating the lower door is arranged in the oil cylinder, a power device which provides power for the door opening device and the transmission device is arranged in the power cavity, an electromagnetic groove is formed in the bottom wall of the power cavity, and a regulating device for controlling the power output position of the power device is arranged in the electromagnetic groove; the control device can control the power device to slide left and right, so that the power output position of the power device is changed, and then the lower door is driven to rotate through the door opening device; through the transmission device, the slave gear and the roller shaft drive the cargo roller to rotate, the cargo is conveyed to the right side of the cargo cavity, and the personnel can be conveniently unloaded.

Preferably, the power device comprises a sliding block which is slidably arranged in the power cavity, a motor for generating power is fixedly arranged in the sliding block, a power shaft which is in power connection with the motor is arranged in the power cavity, and a movable bevel gear is arranged at the top end of the power shaft; a permanent magnet which is slidably arranged in the electromagnetic groove and is fixedly connected with the sliding block; an electromagnet for controlling the permanent magnet to slide leftwards and rightwards is arranged in the right wall of the electromagnetic groove; a spring is elastically arranged between the electromagnet and the permanent magnet; the regulating and controlling device can change the position state of the power device and further control the output direction of the power.

Preferably, the transmission device comprises nine groups of transmission gears which are arranged in the action cavity and are meshed with the slave gears, wherein an upper shaft is arranged in the action cavity, and a main gear meshed with the transmission gear is arranged at the rear end of the upper shaft, wherein a driven belt wheel is arranged at the front end of the upper shaft, a driving belt is arranged between the main belt wheel and the auxiliary belt wheel in a transmission mode, a left bevel gear is arranged at the front end of the lower shaft, a left shaft is arranged in the operation cavity, a slave bevel gear meshed with the left bevel gear is arranged at the left end of the left shaft, and a main bevel gear positioned in the power cavity and meshed with the moving bevel gear is arranged at the right end of the left shaft; the transmission device can transmit power generated by the power device to the auxiliary gear, so that the goods can be conveyed to the right side of the cargo cavity conveniently.

Preferably, and the door opening device is slidably arranged in the piston in the oil cylinder, an arc-shaped block capable of sliding in an arc shape is arranged in the arc-shaped cavity, the arc-shaped block is connected with the lower door through a connecting rod, the left end of the arc-shaped block is connected with the left end of the piston through a left rope, the right side of the piston is connected with the right side of the arc-shaped block through the right rope, and the hydraulic cavity at the lower side is communicated with the left side of the oil cylinder through a lower pipeline, the hydraulic cavity on the upper side is communicated with the right side of the oil cylinder through an upper pipeline; the hydraulic cavity is internally provided with a structure with the same function and similar structure; the hydraulic cavity on the lower side is described in detail; hydraulic oil is arranged in the hydraulic cavity; a pump plate capable of sliding left and right is arranged in the hydraulic cavity; the hydraulic oil is conveyed into the oil cylinder and then passes through the piston and the left rope) and drives the arc-shaped blocks to slide left and right, so as to drive the lower door to rotate, and a rack capable of sliding left and right is arranged in the reciprocating cavity, wherein, and the right side of the rack extends into the hydraulic cavity and is fixedly connected with the hydraulic cavity, a reciprocating gear meshed with the rack is arranged at the rear end of the reciprocating shaft, an auxiliary bevel gear is arranged at the front end of the reciprocating shaft, a right shaft is arranged in the reciprocating cavity, an auxiliary bevel gear meshed with the right bevel gear is arranged at the right end of the right shaft, and a positive bevel gear which is positioned in the power cavity and can be meshed with the movable bevel gear is arranged at the left end of the right shaft; wherein the door opening device can open or close the cargo cavity.

The device has the beneficial effects that the device is simple in structure, convenient to operate and convenient to maintain; the device can automatically convey the cargoes to the right end of the container, so that manual carrying of workers is not needed, the labor intensity is reduced, and the unloading efficiency of cargoes is improved; therefore, the device has relatively high use and popularization values.

### BRIEF DESCRIPTION OF THE DRAWINGS

For better explaining the technical proposal in the present invention embodiments or the prior art, the drawings to be used in the description of the embodiments or the prior art will be briefly described below. Obviously, the drawings in the following description are only some embodiments of the present invention. For those common technicians in this field, other drawings may also be obtained based on these drawings without any creative work.

FIG. 1 is an overall structural diagram of the present invention;

FIG. 2 is an overall structural diagram of the present invention at opening state;

FIG. 3 is a structural diagram of A in FIG. 1;

FIG. 4 is a structural diagram of B in FIG. 3.

### DETAILED DESCRIPTION OF THE INVENTION

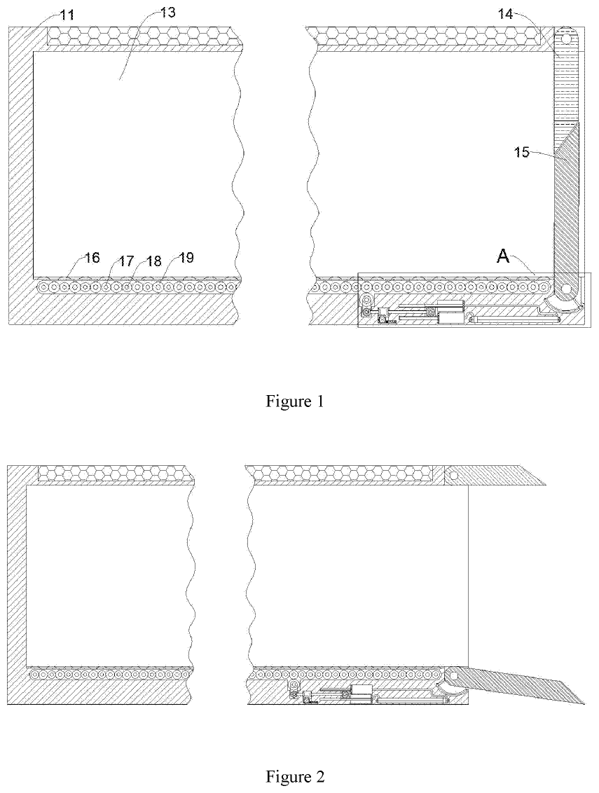

The preferred embodiments of the present invention will be described in detail in the following in combination with the drawings above. For better explanation, the orientations described hereinafter are defined as follows: directions of left, right, front and rear in the text are identical to the directions of up and down of FIG. 1.

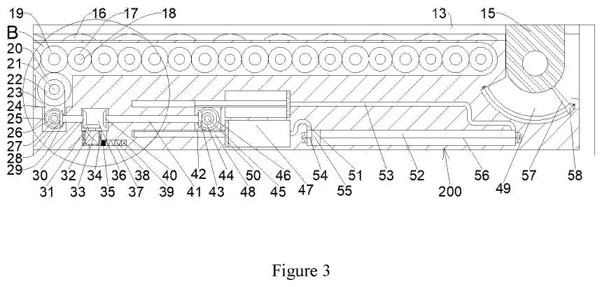

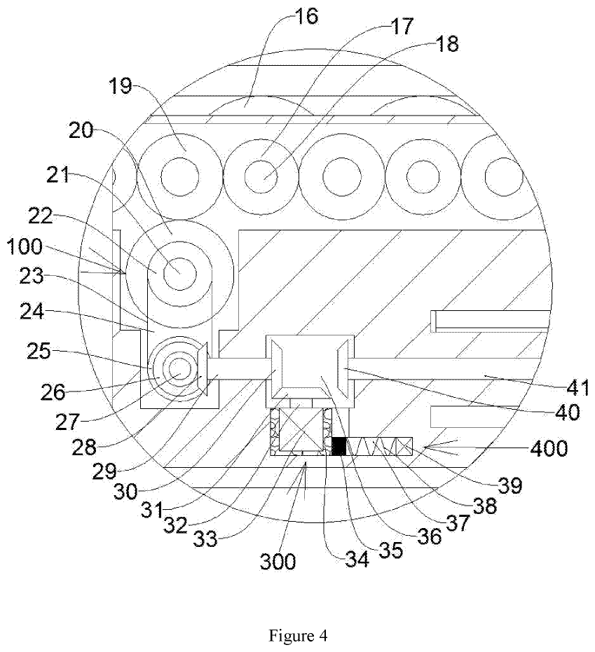

Referring to FIGS. 1-6, the convenient container for unloading comprises a box body 11, and a cargo chamber 13 used for storing cargoes is arranged in the box body 11, and an arc-shaped cavity 49 communicated with the cargo cavity 13 is formed in the right end of the cargo cavity 13, and a rotatable upper door 14 is arranged in the arc-shaped cavity 49, the arc-shaped cavity 49 is provided with a rotatable lower door 15, wherein, the lower door 15 is connected with the upper door 14 through a belt, and the lower door 15 is used for transmitting power to the upper door 14 through a belt, the lower door 15 can be in contact fit with the upper door 14 to seal the cargo cavity 13, wherein, an action cavity 24 is formed in the bottom wall of the cargo cavity 13, a plurality of rolling shafts 18 which are convenient for goods to slide in the goods cavity 13 are arranged in the action cavity 24, and the rear end of the roller shaft 18 is provided with a cargo roller 16 positioned in the cargo chamber 13, wherein a gear 17 is arranged at the front end of the roller shaft 18, a transmission device 100 for transmitting power from the gear 17 is arranged in the action cavity 24, and then the roller 16 can be driven by the gear 17 to rotate through the roller shaft 18, and conveys the cargoes to the rightmost side of the cargo chamber 13, and a power cavity 36 is formed in the right wall of the action cavity 24, and a reciprocating cavity 42 is formed in the right wall of the power cavity 36, and an up-down symmetrical hydraulic cavity 47 is arranged in the right wall of the reciprocating cavity 42, an oil cylinder 52 is arranged in the right wall of the hydraulic cavity 47, the oil cylinder 52 is provided with a door opening device 200 for rotating the lower door 15, a power device 300 for providing power for the door opening device 200 and the transmission device 100 is arranged in the power cavity 36, an electromagnetic groove 37 is formed in the bottom wall of the power cavity 36, and a regulating device 400 for controlling the power output position of the power device 300 is arranged in the electromagnetic groove 37; the control device 400 can control the power device 300 to slide left and right, so that the power output position of the power device 300 is changed, and then the lower door 15 is driven to rotate through the door opening device 200; through the transmission device 100, the slave gear 17 and the roller shaft 18 drive the cargo roller 16 to rotate so as to convey the cargoes to the right side of the cargo chamber 13 so as to facilitate the unloading of people.

The power device 300 comprises a sliding block 34 slidably arranged in the power cavity 36, a motor 33 for generating power is fixedly arranged in the sliding block 34, a power shaft 32 which is in power connection with the motor 33 is arranged in the power cavity 36, and a moving bevel gear 31 is arranged at the top end of the power shaft 32; a permanent magnet 35 slidably arranged in the electromagnetic groove 37 and fixedly connected with the sliding block 34; an electromagnet 39 for controlling the permanent magnet 35 to slide leftwards and rightwards is arranged in the right wall of the electromagnetic groove 37; a spring 38 is elastically arranged between the electromagnet 39 and the permanent magnet 35; the regulating device 400 can change the position state of the power device 300 so as to control the output direction of the power.

The method disclosed by the invention has the beneficial effects that, the transmission device 100 comprises nine groups of transmission gears 19 which are arranged in the action cavity 24 and are meshed with the slave gears 17, and an upper shaft 21 is arranged in the action cavity 24, a main gear 20 meshed with the transmission gear 19 is arranged at the rear end of the upper shaft 21, and a driven belt wheel 22 is arranged at the front end of the upper shaft 21, and a lower shaft 27 is arranged in the action cavity 24, and a main pulley 25 is arranged at the rear end of the lower shaft 27, a left bevel gear 26 is arranged at the front end of the lower shaft 27, a left shaft 29 is arranged in the action cavity 24, a slave bevel gear 28 meshed with the left bevel gear 26 is arranged at the left end of the left shaft 29, and a main bevel gear 30 positioned in the power cavity 36 and meshed with the moving bevel gear 31 is arranged at the right end of the left shaft 29; the transmission device 100 can transmit power generated by the power device 300 to the auxiliary gear 17, so that the goods can be conveyed to the right side of the cargo cavity 13 conveniently.

The method disclosed by the invention has the beneficial effects that, the door opening device 200 is slidably arranged in a piston 55 in the oil cylinder 52, an arc-shaped block 58 capable of sliding in an arc shape is arranged in the arc-shaped cavity 49, the arc-shaped block 58 is connected with the lower door 15 through a connecting rod 57, the left end of the arc-shaped block 58 is connected with the left end of the piston 55 through a left rope 54, and the right side of the piston 55 is connected with the right side of the arc-shaped block 58 through the right rope 56, and the hydraulic cavity 47 on the lower side is communicated with the left side of the oil cylinder 52 through a lower pipeline 51, and the hydraulic cavity 47 on the upper side is communicated with the right side of the oil cylinder 52 through an upper pipeline 53, a structure with the same function and similar structure is arranged in the hydraulic cavity 47, the hydraulic cavity 47 on the lower side is described in detail, hydraulic oil is arranged in the hydraulic cavity 47, a pump plate 50 capable of sliding left and right is arranged in the hydraulic cavity 47, hydraulic oil is conveyed into the oil cylinder 52, and then the left rope 54 and the right rope 54 are connected through the piston 55) and drives the arc-shaped block 58 to slide left and right, so as to drive the lower door 15 to rotate, and a rack 48 capable of sliding left and right is arranged in the reciprocating cavity 42, wherein, the right side of the rack 48 extends into the hydraulic cavity 47 and is fixedly connected with the hydraulic cavity 47, and a reciprocating shaft 45 is arranged in the reciprocating cavity 42, a reciprocating gear 46 meshed with the rack 48 is arranged at the rear end of the reciprocating shaft 45, an auxiliary bevel gear 43 is arranged at the front end of the reciprocating shaft 45, a right shaft 41 is arranged in the reciprocating cavity 42, an auxiliary bevel gear 43 meshed with the right bevel gear 44 is arranged at the right end of the right shaft 41, and a right bevel gear 40 which is positioned in the power cavity 36 and can be meshed with the movable bevel gear 31 is arranged at the left end of the right shaft 41; the door opening device 200 can open or close the goods cavity 13.

When the device is used, the electromagnet 39 is electrified and drives the motor 33 to slide towards the right side through the permanent magnet 35 and the sliding block 34, and meanwhile, the motor 33 begins to forward (reverse)) and drives the moving bevel gear 31 to rotate through the power shaft 32; the moving bevel gear 31 is driven by a front bevel gear 40, a right shaft 41, an auxiliary bevel gear 43, a right bevel gear 44, a reciprocating shaft 45, a reciprocating gear 46 and a lower side (upper side)) the rack 48 drives the pump plate 50 to slide leftwards, hydraulic oil on the lower side (on the upper side) enters the oil cylinder 52 through the lower pipeline 51 (the upper pipeline, and then the piston 55 slides to the left (right), so that the arc-shaped block 58 is driven by the left rope 54 (the right rope, the connecting rod 57 drives the lower door 15 to rotate, and the container is opened (closed).

When unloading, the motor 33 works and passes through a power shaft 32, a moving bevel gear 31, a main bevel gear 30, a left shaft 29, a slave bevel gear 28, a left bevel gear 26, a lower shaft 27, a main pulley 25, a slave pulley 22, an upper shaft 21, a main gear 20, a transmission gear 19 and a slave gear 17.

The device has the beneficial effects that the device is simple in structure, convenient to operate and convenient to maintain; the device can automatically convey the cargoes to the right end of the container, so that manual carrying of workers is not needed, the labor intensity is reduced, and the unloading efficiency of cargoes is improved; therefore, the device has relatively high use and popularization values.

Persons skilled in the art should understand that, the invention is not subject to restrictions of the embodiments above, the embodiments and descriptions stated above only describe the principle of the present invention. The invention will be subject to modification and improvement based on its intention and extent, which will also fall into the claimed protection extent of this invention. The claimed protection extent of the invention shall be determined with reference to the appended claims and any equivalents thereof.

1. A convenient container for unloading, comprises:
a box body,
wherein a goods cavity used for storing cargoes is arranged in the box body,
and an arc-shaped cavity communicated with the goods cavity is formed in the right end of the goods cavity,
and a rotatable upper door is arranged in the arc-shaped cavity, the arc-shaped cavity is provided with a rotatable lower door,
and the lower door is used for transmitting power with the upper door through a belt, the lower door can be in contact fit with the upper door to seal the cargo cavity,
and an action cavity is formed in the bottom wall of the cargo cavity,
one hundred groups of rolling shafts which are convenient for goods to slide in the goods cavity are arranged in the action cavity,
and the rear end of the roller shaft is provided with a cargo roller positioned in the cargo cavity,
wherein a rolling shaft is arranged at the front end of the rolling shaft;
a rotating shaft is arranged at the front end of the rolling shaft,
and a transmission device for transmitting power to the slave gear is arranged in the action cavity, and then the roller can be driven by the gear to rotate through the roller shaft,
and the goods are conveyed to the rightmost side of the goods cavity,
and a power cavity is formed in the right wall of the action cavity,
and a reciprocating cavity is arranged in the right wall of the power cavity, an oil cylinder is arranged in the right wall of the hydraulic cavity, a door opening device used for rotating the lower door is arranged in the oil cylinder, a power device which provides power for the door opening device and the transmission device is arranged in the power cavity, an electromagnetic groove is formed in the bottom wall of the power cavity,
and a regulating device for controlling the power output position of the power device is arranged in the electromagnetic groove.

2. The convenient container for unloading as defined in claim 1, wherein the power device comprises a sliding block which is slidably arranged in the power cavity,
a motor for generating power is fixedly arranged in the sliding block,
a power shaft which is in power connection with the motor is arranged in the power cavity,
and a movable bevel gear is arranged at the top end of the power shaft;
a permanent magnet which is slidably arranged in the electromagnetic groove and is fixedly connected with the sliding block;
an electromagnet for controlling the permanent magnet to slide leftwards and rightwards is arranged in the right wall of the electromagnetic groove;
a spring is elastically arranged between the electromagnet and the permanent magnet.

3. The convenient container for unloading as defined in claim 1, wherein the transmission device comprises nine groups of transmission gears which are arranged in the action cavity and are meshed with the slave gears,
wherein an upper shaft is arranged in the action cavity,
and a main gear meshed with the transmission gear is arranged at the rear end of the upper shaft,
wherein a driven belt wheel is arranged at the front end of the upper shaft,
a driving belt is arranged between the main belt wheel and the auxiliary belt wheel in a transmission mode,
a left bevel gear is arranged at the front end of the lower shaft,
a left shaft is arranged in the operation cavity,
a slave bevel gear meshed with the left bevel gear is arranged at the left end of the left shaft, and a main bevel gear positioned in the power cavity and meshed with the moving bevel gear is arranged at the right end of the left shaft.

4. The convenient container for unloading as defined in claim 1, wherein and the door opening device is slidably arranged in the piston in the oil cylinder,
an arc-shaped block capable of sliding in an arc shape is arranged in the arc-shaped cavity,
the arc-shaped block is connected with the lower door through a connecting rod,
the left end of the arc-shaped block is connected with the left end of the piston through a left rope,
the right side of the piston is connected with the right side of the arc-shaped block through the right rope,
and the hydraulic cavity at the lower side is communicated with the left side of the oil cylinder through a lower pipeline,
the hydraulic cavity on the upper side is communicated with the right side of the oil cylinder through an upper pipeline;
the hydraulic cavity is internally provided with a structure with the same function and similar structure;
the hydraulic cavity on the lower side is described in detail; hydraulic oil is arranged in the hydraulic cavity;
a pump plate capable of sliding left and right is arranged in the hydraulic cavity;
the hydraulic oil is conveyed into the oil cylinder and then passes through the piston and the left rope) and drives the arc-shaped blocks to slide left and right, so as to drive the lower door to rotate,
and a rack capable of sliding left and right is arranged in the reciprocating cavity,
and the right side of the rack extends into the hydraulic cavity and is fixedly connected with the hydraulic cavity,
a reciprocating gear meshed with the rack is arranged at the rear end of the reciprocating shaft,
an auxiliary bevel gear is arranged at the front end of the reciprocating shaft,
a right shaft is arranged in the reciprocating cavity, an auxiliary bevel gear meshed with the right bevel gear is arranged at the right end of the right shaft,
and a positive bevel gear which is positioned in the power cavity and can be meshed with the movable bevel gear is arranged at the left end of the right shaft.
